(19) United States
(12) Patent Application Publication
(10) Pub. No.: US 2004/0193610 A1
(43) Pub. Date: Sep. 30, 2004

(54) Digital interactive network appliance and system

(76) Inventors: Cary Alex, Brooklyn Heights, NY (US); Howard Chesloff, Plainview, NY (US)

Correspondence Address: Gottlieb Rackman & Reisman, 270 Madison Avenue, New York, NY, 10016-0601, US

(21) Appl. No.: 10/491,835

(22) PCT Filed: Oct. 17, 2001
(86) PCT No.: PCT/US01/32253

(51) Int. Cl. G06F 17/30

(52) U.S. Cl. 707/10

(57) ABSTRACT

A system and process for a network appliance (12) at a point-of-sale location and adapted to provide information and other services to customers. The system and process are particularly well suited for offering individual entertainment to kiosks. Examples of services include music, video, games, internet access (20), electronic mail, commercial advertising, menus, and ordering. Customers can purchase services with debit or credit cards.

### RELATED APPLICATION

This application claims priority to provisional application S.N. 60/240,664 filed Oct. 16, 2000 entitled Digital Interactive Network Appliance and incorporated herein by reference.

### BACKGROUND OF THE INVENTION

A. Field of Invention

This invention pertains to a network appliance at a point-of-sale location and adapted to provide information and other services to customers. More particularly the present invention pertains to a network appliance and associated system that provides Internet access and other services to the patrons or customers in a restaurant.

B. Description of the Prior Art

Many times people go to a restaurant and other similar establishments (i.e. diners, bars, etc) not only to eat but also to be entertained. Therefore some restaurants provide entertainment means including canned music, juke boxes, and so on, in order to attract customers and obtain additional revenue.

However, the choice available to patrons tend to be limited. For example, juke boxes only offer at most a few dozen audio selections. Game machines, such as pin ball, have limited offerings. And at popular restaurants, customers must either wait in line to order or wait for a waiter to come and take down an order. That is, ordering is done at the convenience of the restaurant staff, and not at the convenience of the customer.

There is a need to automate and deliver entertainment and ordering services. That is, unlike the present system, customers need to choose from a large number of audio and video selections, pick from any number of games, and have automated menu order entry and payment at their convenience.

### OBJECTIVES AND SUMMARY OF THE INVENTION

An objective of the present invention is to provide an interactive network device that can play musical audio and video selections, video games and other similar entertainment programs.

A further objective is to provide an interactive network device that can play entertainment programs using a fee based system, i.e., a system in which the customer pays for the entertainment programs.

A further objective is to provide an interactive network device that is also adapted to provide TV quality advertising to customers.

A further objective is to provide a fee based network device that may be used to provide information to customers such as news, business, and financial information.

Yet another objective is to provide an interactive network device that may also be used to place orders and to pay for the orders.

Briefly, the present invention encompasses a system that provides fee-based entertainment, advertisements and provides other services to the customers of a restaurant. The system includes a server and a plurality of interactive network appliances, each appliance being arranged positioned and constructed so that it is easily accessible to the customers. For example, the device may be positioned on a table, a wall adjacent to the table, a pedestal and so on. The device includes a screen for displaying images, an input device for receiving commands from the customers (such as a touchscreen) and other elements normally associated with PCs. The device is connected by a wired or wireless connection to the server. Importantly, each device is also provided with a card reader/writer adapted to read a card provided to each customer.

The customer may use the card to pay for the entertainment programs, as well as food and other services received from the restaurant. Upon inserting the card into the card reader, the screen may display the card balance. The card is not necessarily restricted to use in the restaurant; it may be used as a telephone, credit, debit, bank, and ID card. One example of a card use is to purchase movie, theater, and concert tickets from home. In this use, a file on the home computer knows the card number. The patron goes online and selects the show and orders tickets. When the patron goes to the show, he presents the card, the price of the show is debited, and he is allowed in.

The customer may also engage in video gaming using game pads which optionally flip-up and stow away when not in use. Speakers, and volume control, may be provided for audio entertainment. Speakers may be arranged to restrict sound to patrons in the immediate vicinity. If music is played at two adjacent locations, the volume at each location may be adjusted so that it will not interfere with the users at the other location. Centralized or local printers may be provided to enable patrons to print out email, news, menus, specials, and coupons, for example. The server may permit multiple tasks to performed at the same time. For example, music may be played at the same time that a game is being played.

The server may be located in a back room.

Several servers at different locations may be connected by either a standard Internet connection or a secure private connection to a central location for receiving inventory, sales and other data from the servers, distribute entertainment programs and so on.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 shows a block diagram of a system constructed in accordance with this invention;

FIG. 1A-1X show flow charts for various operations that can be performed on the system of FIG. 1;

FIG. 2 shows a user configuration for the system of FIG. 1;

FIGS. 3A and 3B shows a first embodiment of the screen for the system of FIG. 1;

FIGS. 4A and 4B shows a second embodiment of the screen for the system of FIG. 1; and

FIG. 5 shows a third embodiment of the screen for the system of FIG. 1.

### DETAILED DESCRIPTION OF THE INVENTION

The following description is of the best presently contemplated modes of carrying out the invention. This description is made for the purpose of illustrating the general principles of the invention and is not to be taken in a limiting sense.

It is anticipated that the invention will positively alter the experience of dining, especially at a fast food restaurant. Upon entering a restaurant, a patron does not need to wait on a line to order or wait for a waiter; the patron takes a seat at a table. On, to adjacent to, the table is a system with a touch screen which will present menu choices, daily specials, coupons, and advertising. Pictures of menu items can be displayed. The patron makes selections and orders through the touch screen.

When the patron places an order, the restaurant can build a database of items ordered by the customer. This database may be tied into suppliers who sell items (e.g., soft drinks) and advertising content can be tailored to the patron. In addition, once the patron returns home, promotional items may be forwarded to him and he may download coupons.

In addition to the menu and order system, there may be a selection of free and“pay for play” entertainment. That is, entertainment options including audio and video selections may be presented to a patron. Because the table system may be linked to a back room server, which in turn may be linked to other servers, the potential number of selections can be large (much more than any juke box could ever present). The server permits simultaneous play of a selection through any number of techniques (file download to network device, file copy and streaming download, and file multiple access).

The free entertainment may be supported by advertising. In addition to specific messages delivered to the patron, the price of the system may be in part or whole offset by a supplier. In return, the restaurant may agree to use exclusively the supplier.

Not only multimedia entertainment, but video games may be available through the touch screen. Optional joystick, keypad, and game paddles can allow a patron to pick from any number of online games. The patron may reach, say, level 2 in the game, then return home, log onto the internet, and continue the same game starting at the same level.

Because the system and back room server can be networked, the patron may request email, news, and financial reports through the system.

To pay for the meal, entertainment, and information services, the system can present a patron with several choices. First, the system can feed invoicing information to the server which tallies a bill and can be presented to the patron, who pays in a traditional manner (i.e., cash, check, or credit card). Second, the system can have a card reader so the patron can use a credit or bank debit card to pay. Or, the patron may use a frequent diner or prepaid card. This option, through specials, discounts, and rebates, can encourage repeat business.

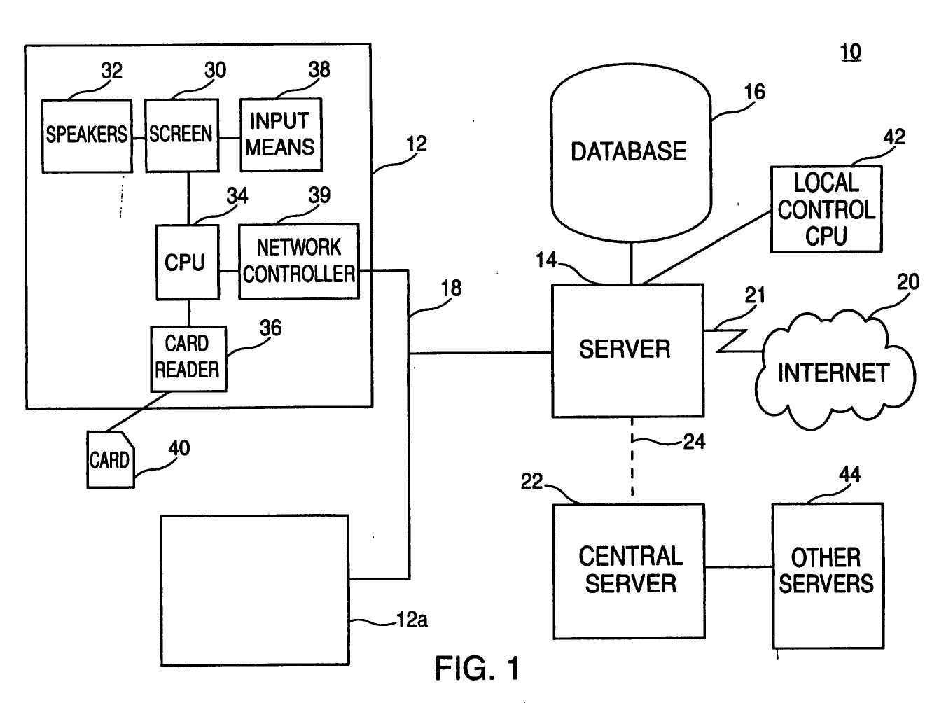

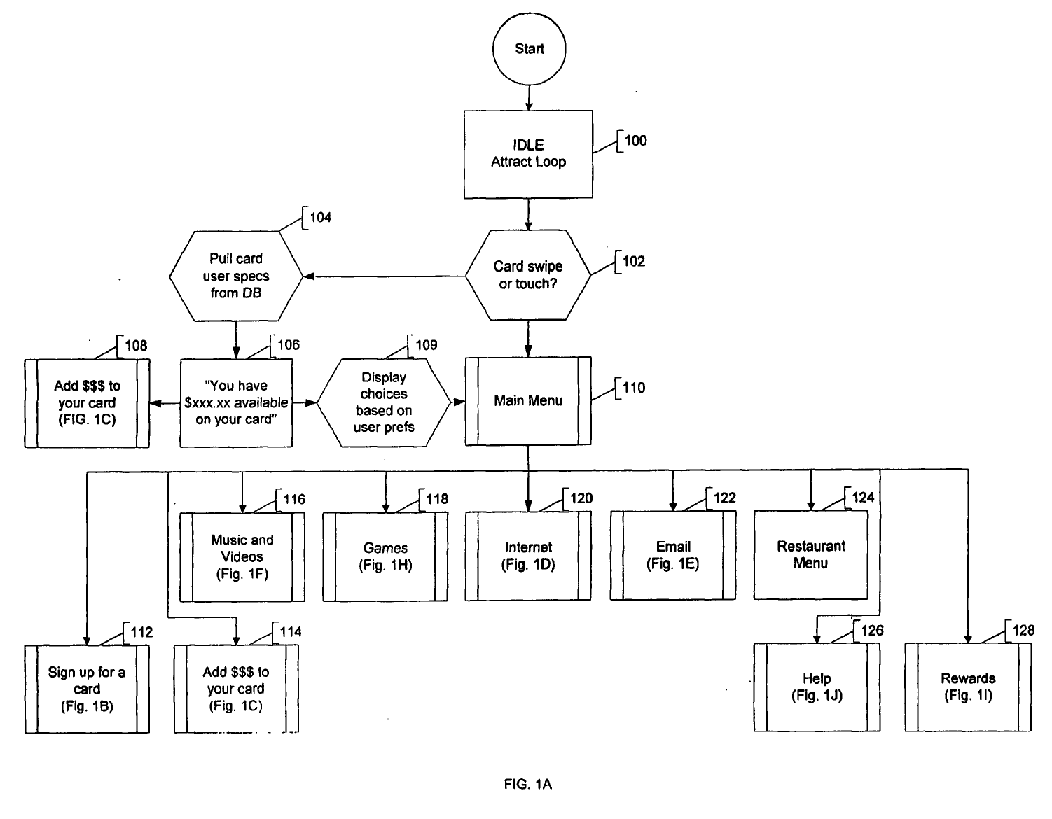

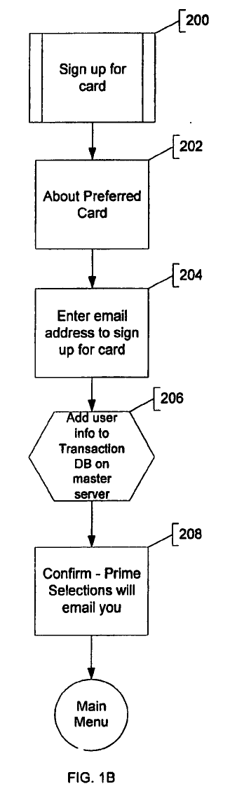

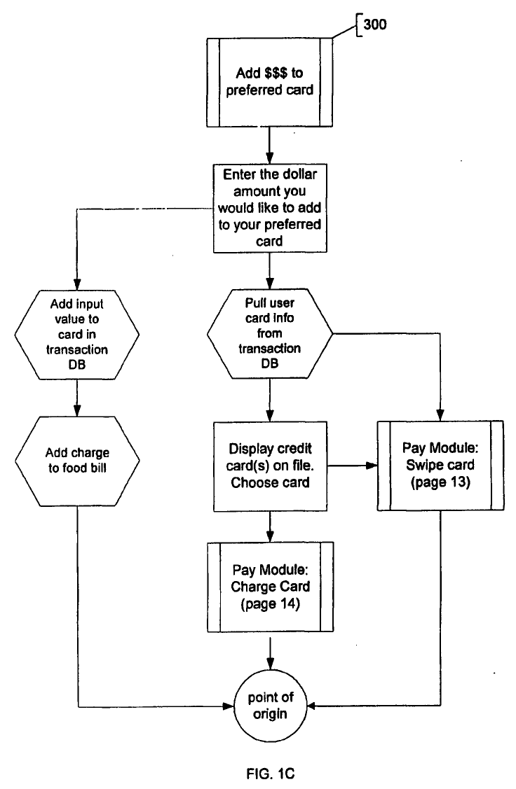

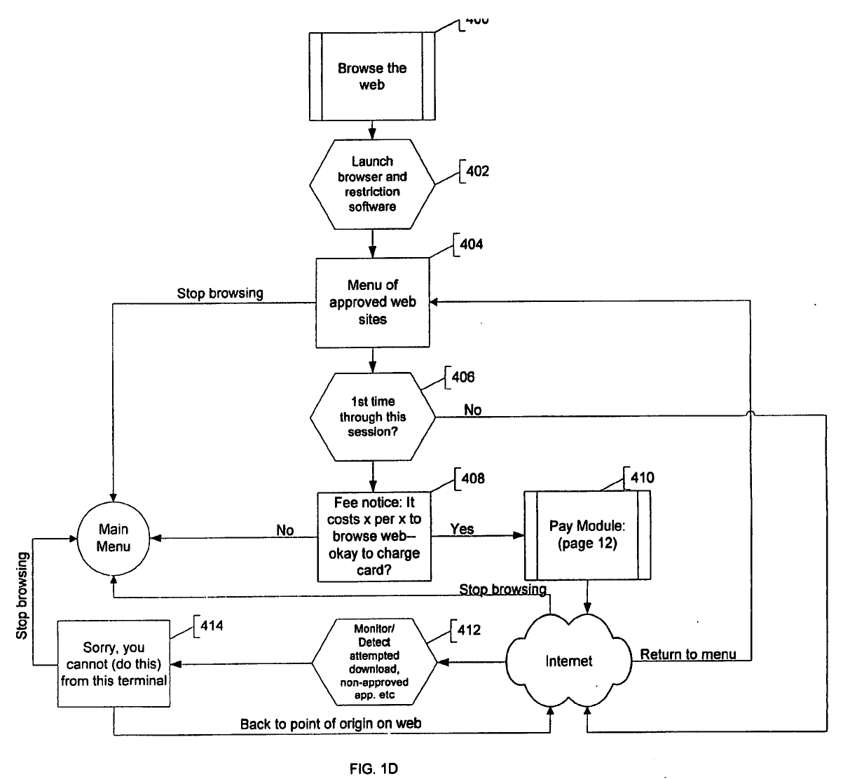

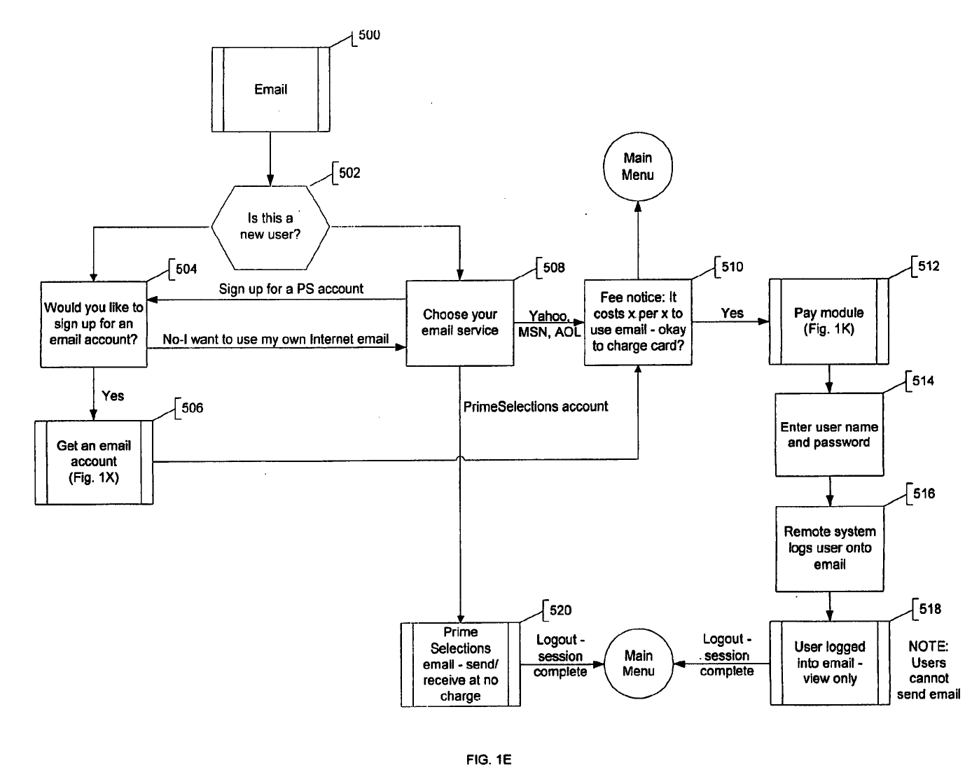

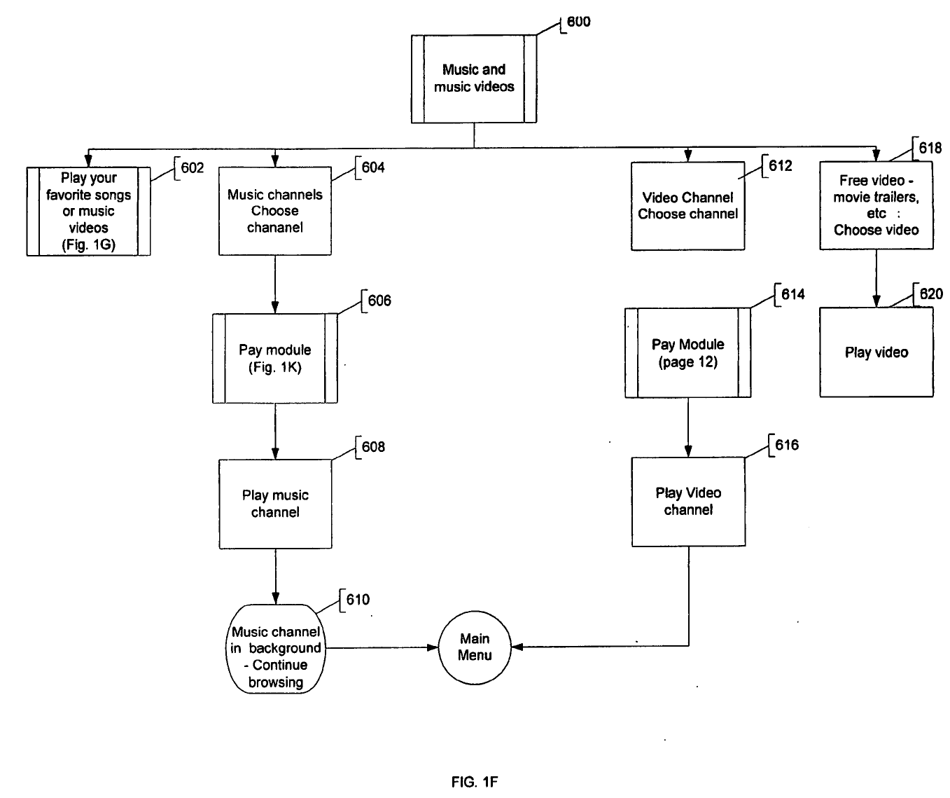

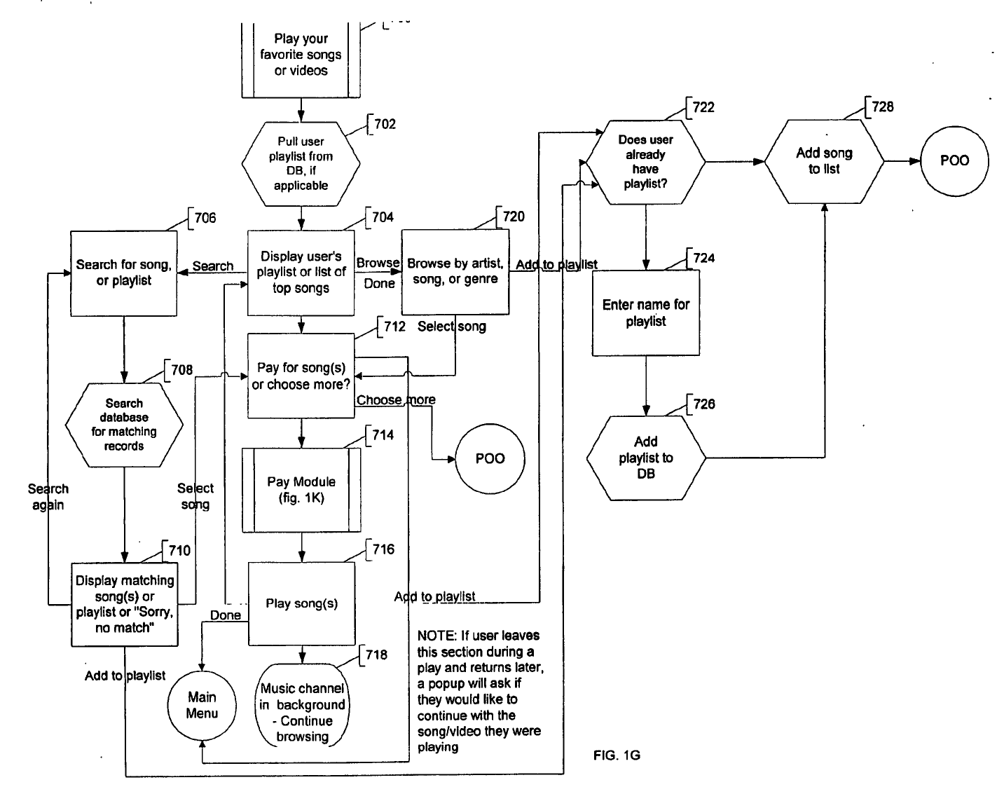

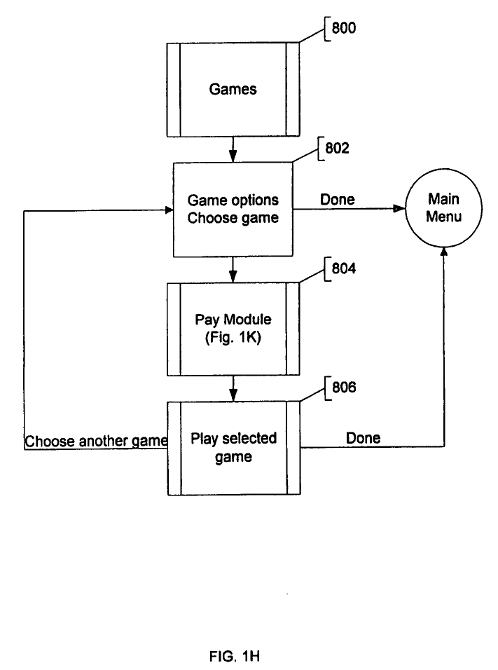

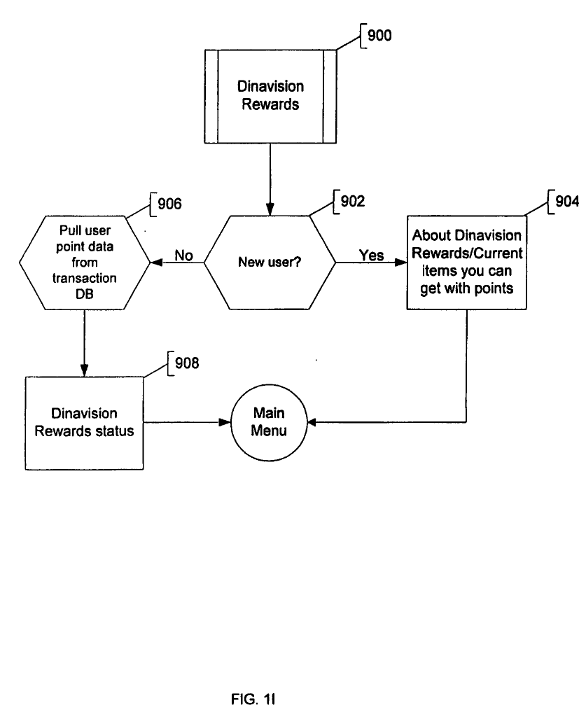

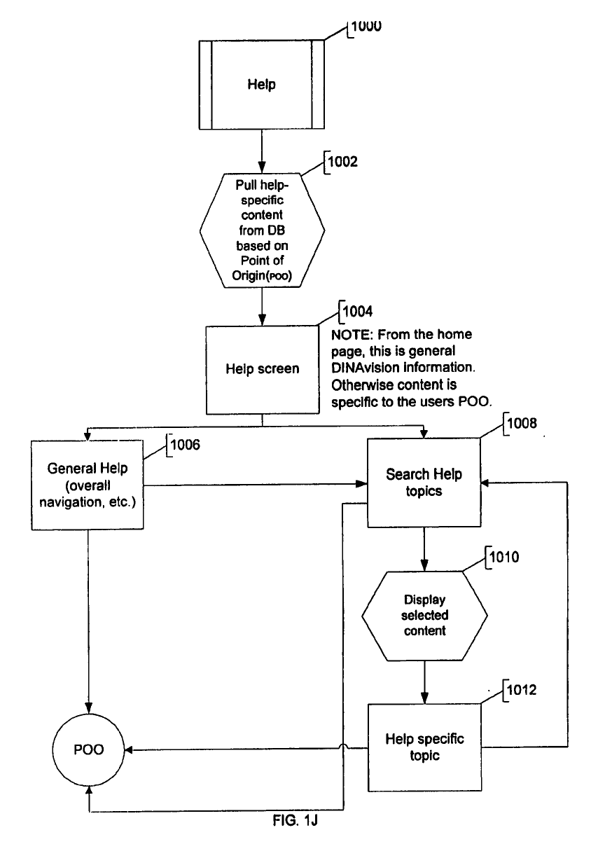

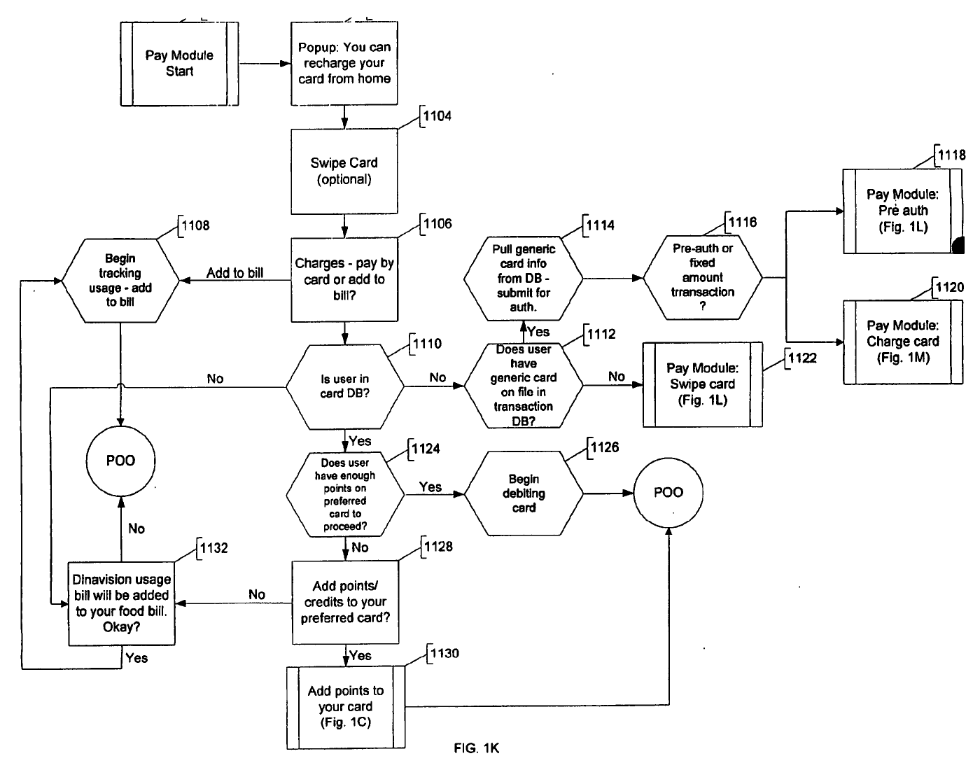

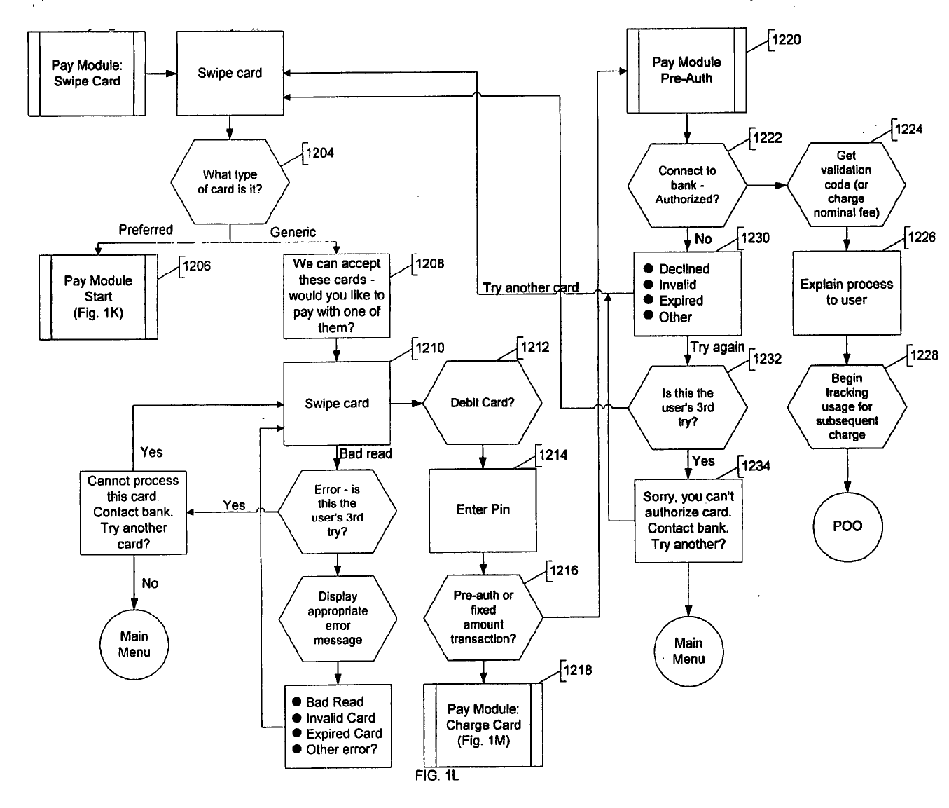

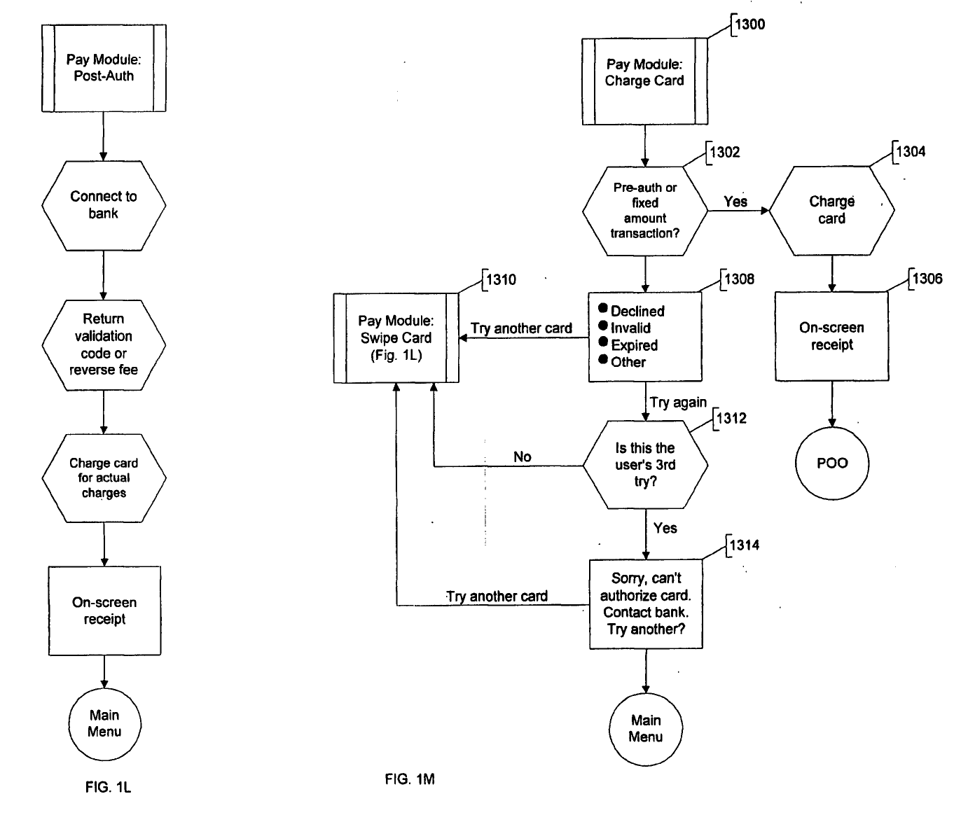

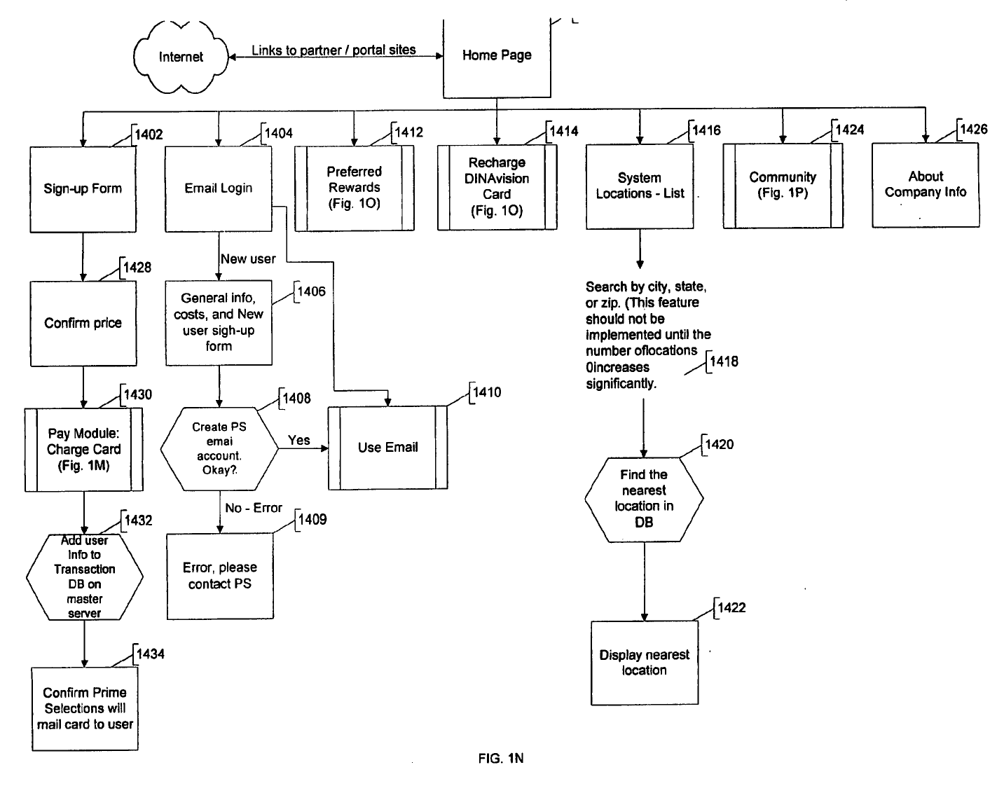

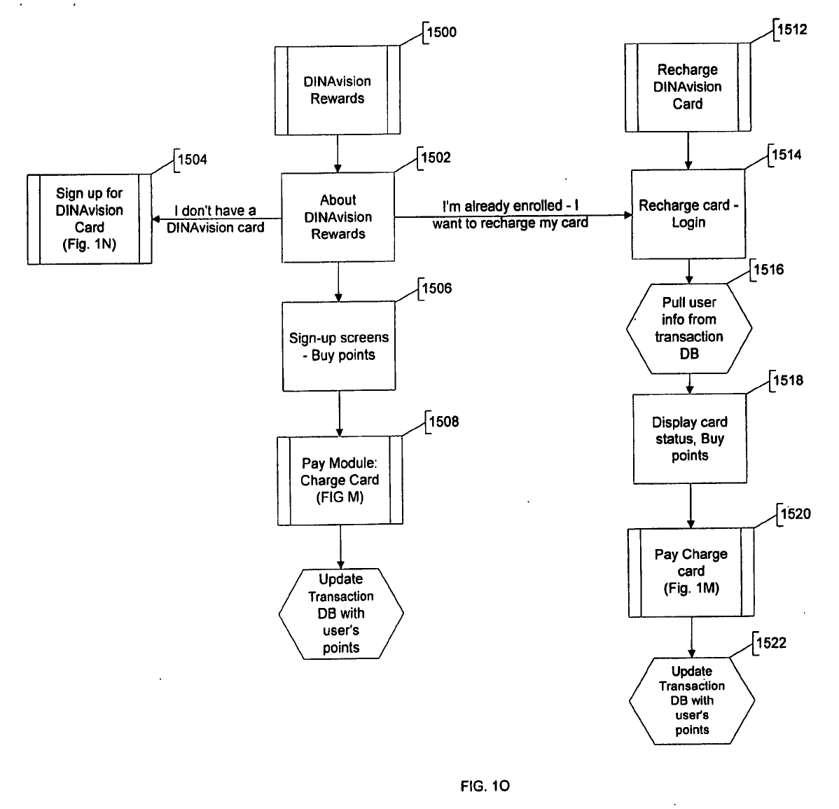

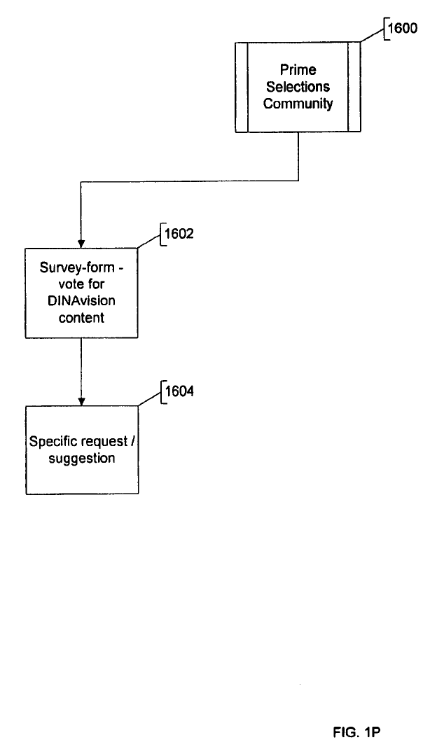

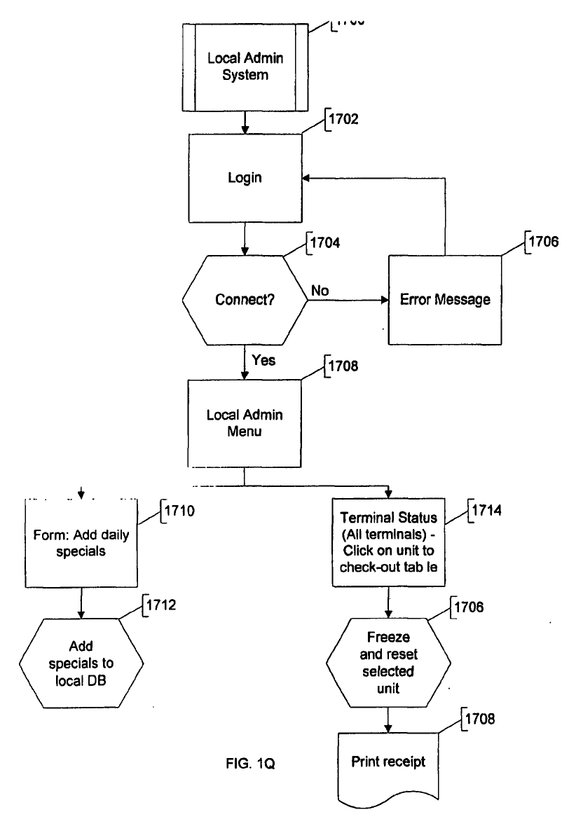

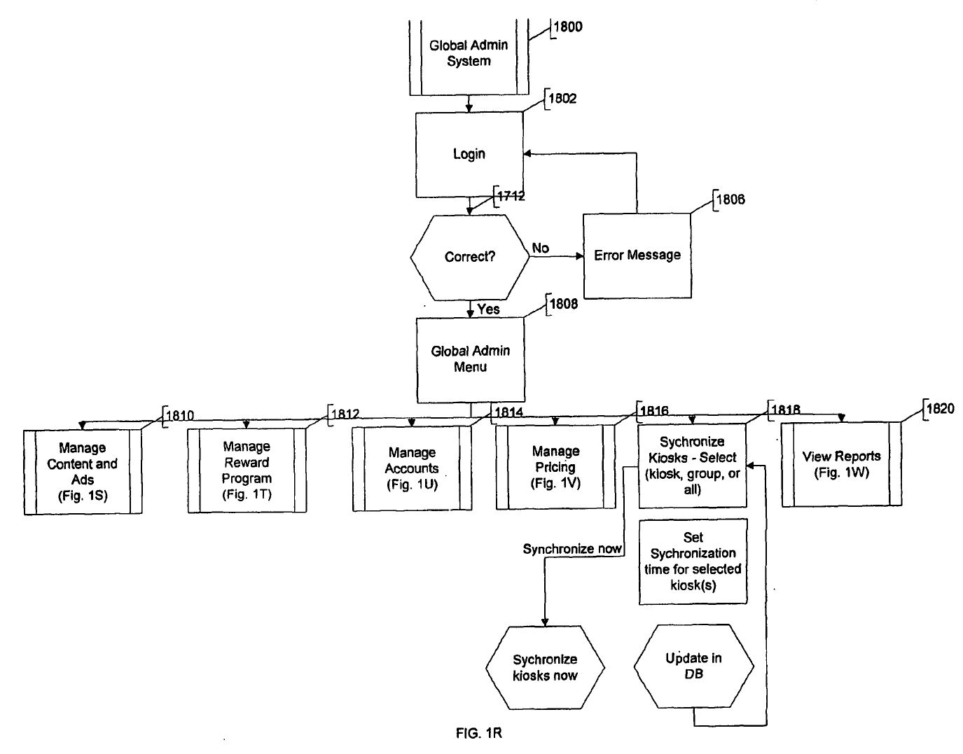

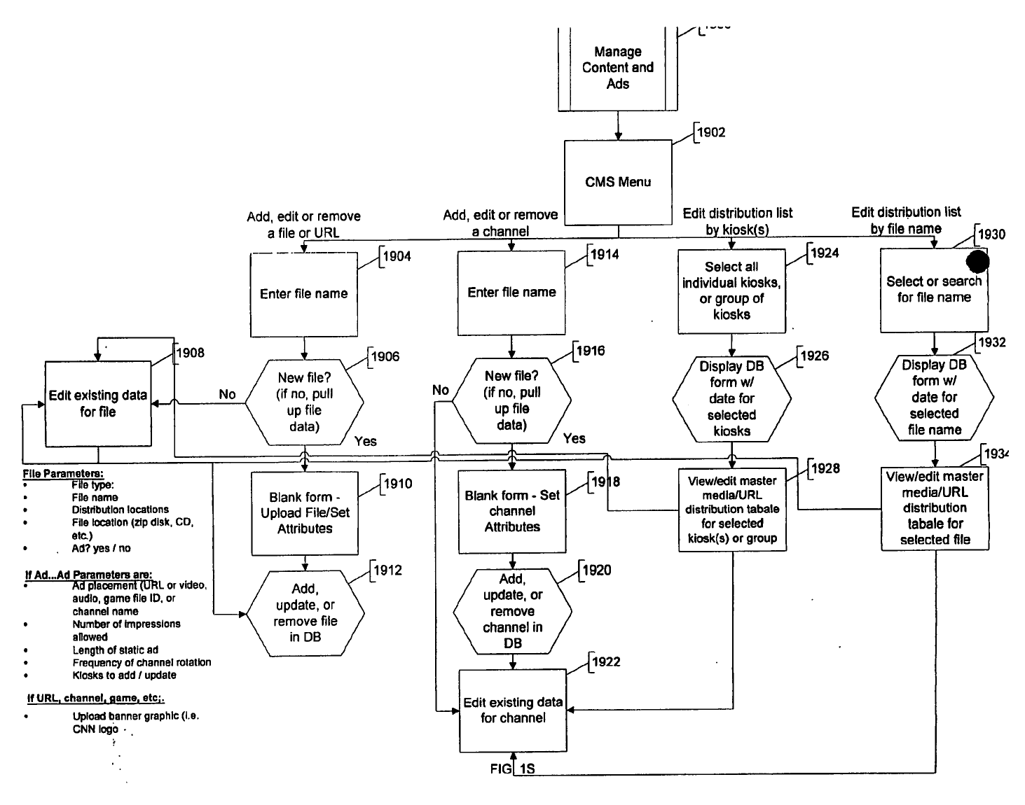

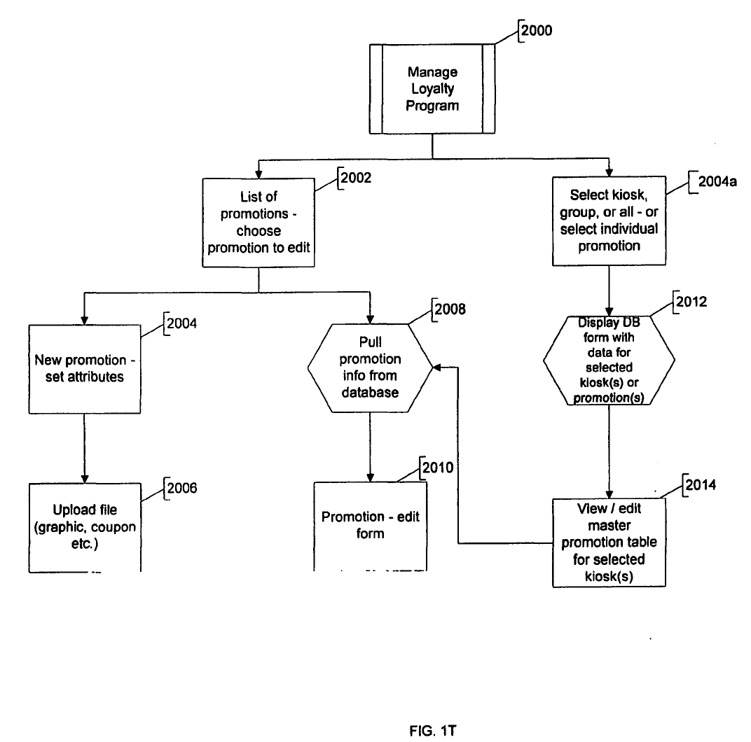

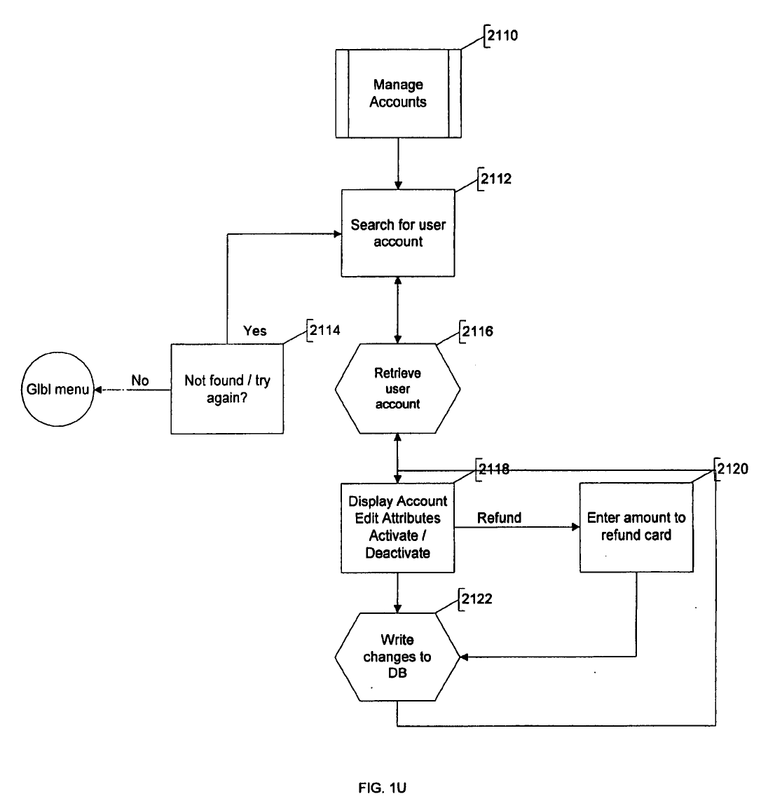

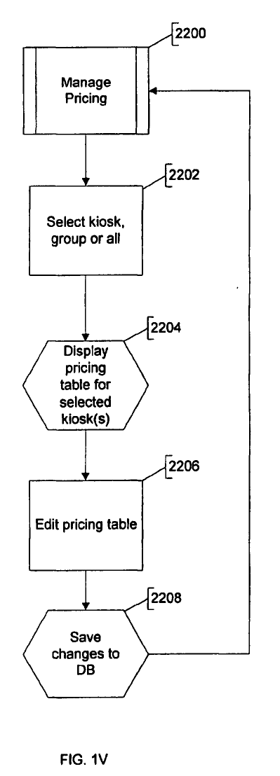

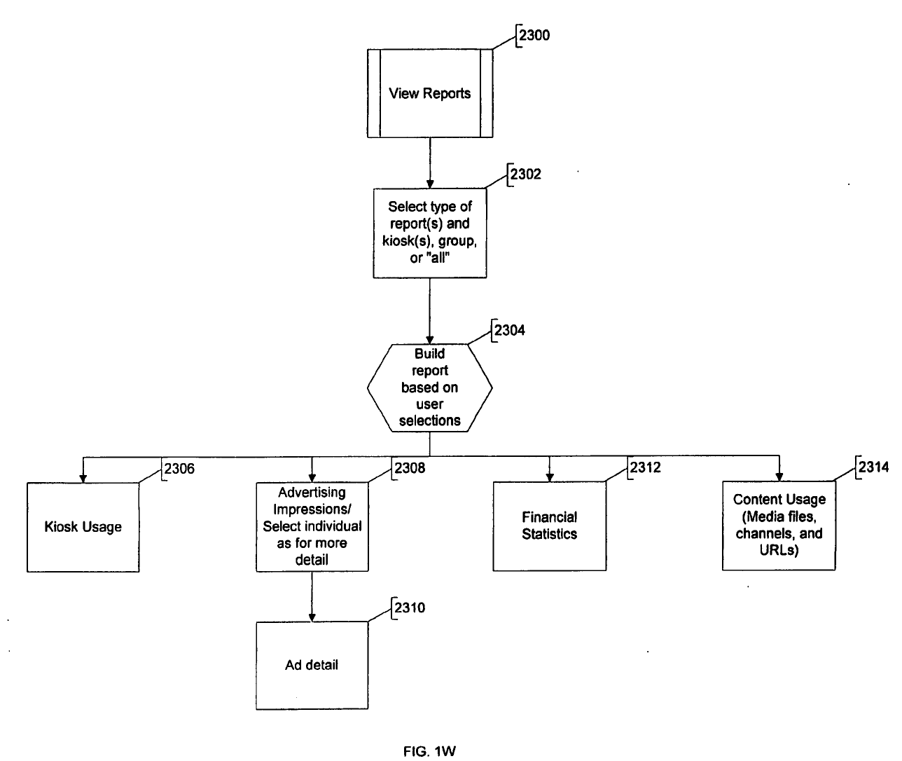

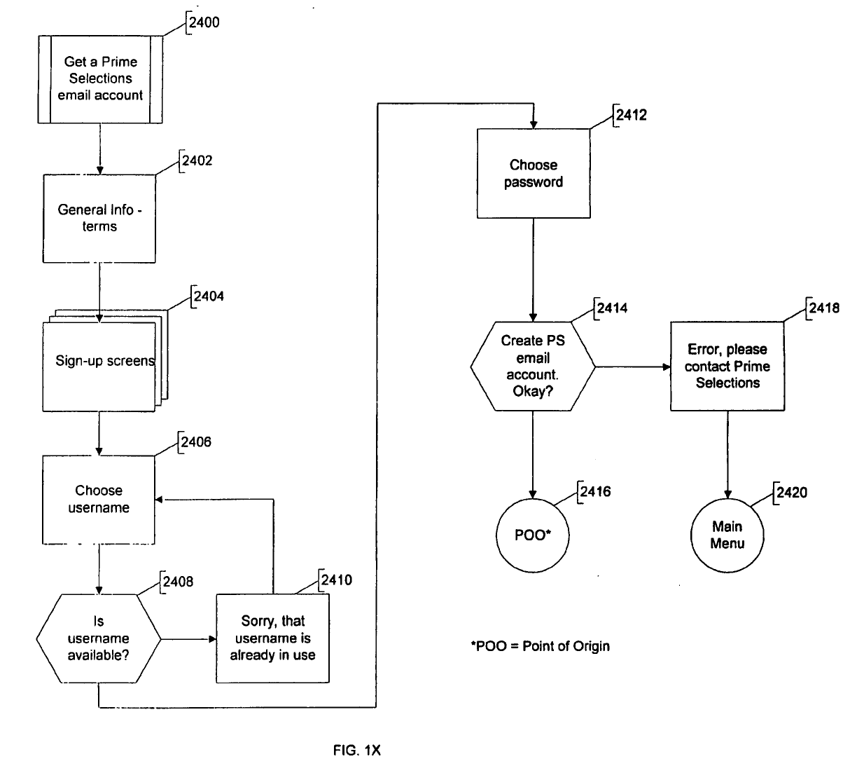

FIG. 1 shows a system 10 constructed in accordance with this invention. It is contemplated that the system 10 is disposed at a single location, such as a restaurant, however the system may also be distributed over several locations with the components being interconnected by a suitable network. The system 10 includes one or more interactive network devices (or devices for short) 12 and 12a, for example, and a server 14. The server is associated with a data base 16. The devices 12 and 12a are connected to the server 14 via standard wired or wireless network 18. In addition, the server has access to the Internet 20 through an Internet connection 21. The server 14 may also be connected to a central server 22 disposed at a different location. This latter connection may be implemented through the Internet or via a secure or private network 24.

Each device 12 includes a screen 30, one or more speakers 32, a CPU 34, a card reader 36, an input means 38 and a network connection means 39. Thus input means 38 can be implemented using standard components used for a PC.

A user can pay for charges related to the services by inserting a card 40 (or swiping the card) in card reader 36. Card 40 can be either a preferred card (e.g., a card issued for the specific purpose of using the system 10) or a generic (credit or debit) card issued by a third party.

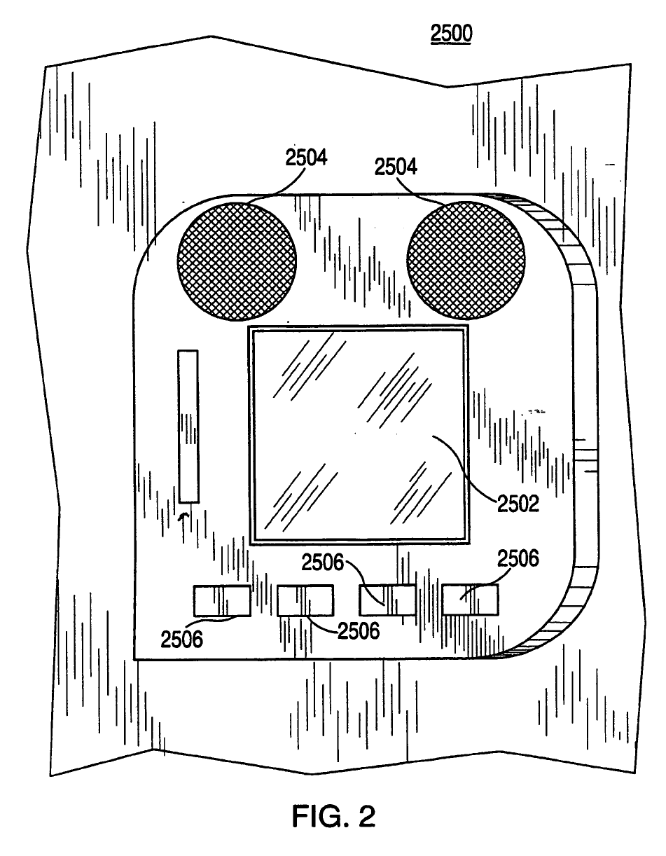

FIG. 2 is a user configuration 2500 for system 10. The user is presented with a screen 2502 (preferably a touch input screen), input buttons 2506, card reader 2508, and speakers 2504.

The operation of the system is now described in conjunction with the flow charts of FIGS. 1A-1W.

Starting with FIG. 1A, in step 100 a particular device 12 is in an idle mode. In this mode, device 12 displays welcome message, advertisements, a menu, or specials from the respective restaurant or other merchants. In step 102, an action from a customer is detected that may be either the introduction of a card into the card reader 36 or through the input means 38.

If a preferred card is sensed, then in step 104 the customer (or at least his/her card) is identified, and the current balance on the preferred card is retrieved from the data base 16. In step 106, a statement is shown on screen 30 (and/or played on the speakers 32) indicating the balance. If this balance is below a threshold, in step 108 the customer is given the opportunity to add more funds to the balance. This process is described in more detail below in conjunction with the flow chart of FIG. 1C. If the balance is sufficient, then in step 109 a set of choices are retrieved based on the customer's preferences stored in the data base. These preferences are updated regularly from the central server. If no references are found, or if in step 102 the input means is activated, then in step 110 a whole set of choices are displayed. The customer then picks one of these choices thereby activating a respective feature or operation of the invention.

The following are some of the choices that may be presented to the customer or a visitor:

Sign up and get preferred card (step 112)-see FIG. 1B;

Add money to preferred card (step 114)-see FIG. 1C;

Select and Play music (audio or video)(step 116)-see FIG. 1F and FIG. 1G;

Select a Game (Step 118)-see FIG. 1H;

Browse the Internet (step 120)-see FIG. 1D;

Access an e-mail program (step 122)-see FIG. 1E and FIG. 1X;

Get restaurant menu (step 124);

Get Help (step 126)-See FIG. 1J;

Get rewards (Step 128)-See FIG. 1I.

The sign up process is shown in FIG. 1B. The process is initiated in step 200. In step 202, information is displayed regarding the preferred card offered to customers, its advantages, costs, and so on. In step 204, the user enters his e-mail address. In step 206, the user provides additional information as requested. This information is stored in the data base 16. In step 208, the collected information is displayed to the user so that he can check it for accuracy. The information may be transmitted to the user via an e-mail message as well.

The preferred card may be set up as credit or debit card. If it is a debit card, it needs to be recharged if it has been depleted. The process for adding funds to a preferred (debit) card is shown in FIG. 1C. The process is initiated in step 300.

The sign up process for email is shown in FIG. 1X. The process is initiated in step 2400. In step 2402, information is displayed regarding general information including terms and conditions. Then sign-up screens are presented to the user in step 2404. A username is selected in step 2406. If the selected username is not available, step 2410 prompts the user to select another username. If however, step 2408 determines that the username is available, the user is prompted to select a password at step 2412. Step 2414 determines if the email account can be created; if so, the user is returned to the point of origin, step 2416. If not, an error message is displayed to the user, step 2418, and the user is returned to the main menu, step 2420.

The process that allows a customer to access the Internet is shown in FIG. 1D. The process is initiated in step 400. In step 402, a standard browser is launched. The browser is initially set up so that it does not show any pop-ups, and cannot initiate any downloads or programs. In step 404, a menu of approved sites is displayed. These are the sites that are available for selection by the user. In step 406, a check is performed to determine if this is the first visit by the user. If it is not, then the user is allowed to view the selected site through the Internet. If this is the user's first time, then in step 408 a fee schedule is displayed. If the user agrees, then the payment processed is initiated in step 410. If the user decides not to pursue this feature, then he is returned to the main menu (FIG. 1A, step 110). Any time the user stops browsing, he is returned to the main menu as well.

The activities of the user during browsing are monitored through step 412. If a prohibited activity (such as executing programs, downloading files, or accessing non-approved web sites), then in step 414 a message is displayed to indicated that the respective activity is not allowed, browsing is terminated, and the user is returned to the main menu. Because of the public and family oriented locations of the network devices, restricted access to specific web pages may be necessary.

It should be emphasized that network device locations are not restricted to restaurants; they may be located anywhere people may have to wait. Examples include hospitals, nursing homes, beauty parlors, laundromats, airports and airplanes, and all types of waiting rooms.

The process for sending/receiving e-mail is shown in FIG. 1E. The process is initiated in step 500. In step 502, a check is performed to determine if the user is a new user. If a new user is detected, then in step 504 he is given a choice of getting e-mail from a favorite provider. For example, the system 10 itself may be set up to provide e-mail service. If the new user selects this option, then a new e-mail account is set up for him in step 506. This process is described in more detail below in conjunction with FIG. 1F. Otherwise, the user can select a different e-mail provider (i.e., YAHOO, MSN, AOL) (step 508). In step 510, the new user is then provided with a price schedule for the e-mail service. If he selects to proceed, then his account is charged in step 512. In step 514, the user enters his name and address. In step 516, the user is logged to the respective remote e-mail server. In step 518, the user is logged on to the remote e-mail and can view his e-mail messages. Preferably, the user cannot send messages in this mode. When user logs off, he is returned to the main menu.

Back to step 508, if the user selects the preferred e-mail server, then in step 520 he can send or receive e-mail messages. After he is finished, he is returned to the main menu.

FIG. 1F shows the process for playing music. The process is initiated in step 600. As part of step 600, a menu is displayed with various choices, including making a selection from a preferred list, selecting a pay audio or video channel, playing a free audio or video channel, etc.

Step 602 allows the user to play a selection from a predetermined list of favorite selections. This process is described in detail below in conjunction with FIG, 1G.

Step 604 allows the user to choose from several pay music channels. Once a selection is made, in step 606 payment is collected. In step 608, the selected music channel is played. Not only is the selected music played, but there is the option for a free song (say one that a publisher wants to promote) to be paired with it. In step 610, the selected channel may be stored in the data base as part of the user's favorite list.

Step 612 allows a user to select from a plurality of pay video channels. Not only may this include music videos and local programming, but it also may include television broadcast shows. In step 614, payment for the selected video channel is collected. In step 616 the selected video is played.

In step 618, the user is presented with selections of free audio and video channels. When the user makes a selection, the appropriate channel is played in step 620.

The process for playing selections from a user's favorite list is shown in FIG. 1G. The process is initiated in step 700. In step 702, the user's favorite list (if any) is retrieved from the data base. In step 704, the list of favorites is displayed for the user and the user can decide to either search through the list for particular selection(s) or can browse through a general list of selections.

If he decides to search his favorites list, then in step 706 the user selects his search criteria (i.e., title, artist, instrument, etc.). In step 708, the list is searched using the selected search criteria. If selections are found matching the search criteria, then these selections are displayed in step 710. In step 712, the user can chose to pay for the selections already made or continue searching for more selections. If he decides that he has finished choosing, then in step 714 payment for the selections is collected and in step the selections are played. In step 718, music plays in the background while the patron is browsing.

If in step 710 no selections are found, an error message is displayed and the user can enter more search criteria.

If the user elects to browse through the general list, he may do so in step 720, using such criteria as the name of an artist, composer, genre, etc. The selections found by browsing the general list are handled in step 712 in the same manner as described above.

Optionally, whenever the user selects one or more selections from the general list, he is given an option to add these selections to his favorites list and to generate such a list if he does not already have one. For this purpose, in step 722 a determination is made as to whether the user has a favorite list. If he does not, then in step 724 a favorite list is established and named. In step 726, the name of the new favorite list is entered into the data base. In step 728, the new selection(s) is entered into the favorite list of the user. The user may access the play list from any location that is a participant in the subject system.

The process for playing a game is shown in FIG. 1H. The process is initiated in step 800. In step 802, the user is shown a plurality of games that are available for playing. After the user makes a selection, payment is collected in step 804 and the game is then played in step 806. At the end of the game the user can chose (and pay for) another game or can return to the main menu.

The process for displaying rewards to the user is shown in FIG. 1I. The process is initiated in step 900. In step 902, a determination is made as to whether this is a new user. If he is, then the rules governing the rewards program and the current items or services available through the program are shown. If the user is not a new user, then in step 906 the number of points or other rewards awarded as part of the program are retrieved from the data base and shown. In step 908, other information is shown to the user. For example, if the user has requested to exchange some of his points for items or services, the status of this order is shown to the user in step 908.

The help process is shown in FIG. 1J. The process is initialized in step 1000. In step 1002, instructions specific to the last activity by the user is retrieved from the data base and displayed in step 1004. If no such instructions are found, then in step 1006 the user is provided with general instructions for using the system. Alternatively from step 1004 or 1006 the user may choose to look for further, more specific help instructions using search tools in step 1008. The list instructions found by the search tools are displayed in step 1010. The user can then select one of these instructions and the selected instruction is displayed in step 1012.

The payment process is shown in FIG. 1K. The process is initiated in step 1100. In step 1102, a message is shown to the user indicating that the user can recharge his card at home as well. This process is described below in conjunction with the flow chart of FIG. 1N. In step 1104, the user is asked to swipe his card through the card reader 36. If the user has swiped his card previously, or if the user has authorized a different mode of payment, for example by charging his generic card, then this step is omitted.

In step 1106, the user is given the choice of paying for the current charges (for the use of the device 12) either directly by debiting his card 40 or by adding the charges to his restaurant bill. If the user selects to add the charges to his bill, then in step 1108 the charges associated with device 12 are monitored and added to the user's regular bill. The user's regular bill (which covers the food, drinks, etc.) is managed using standard processes which are not described further but which can be handled manually, by the system 10 or by an independent computerized system.

If in step 1106, the user decides to pay for charges with his card, then in step 1110 a check is performed to determine if the user has swiped a preferred card and if the user is identified in the database as having a preferred card. If the user did not provide a preferred card, then in step 1112 a check is performed in the database to determine if the user has previously identified a generic card as a means of payment. This information is found in the database 16. If the user has made such an authorization, then in step 1114 the information regarding this generic card is retrieved from the database. In step 1116, a check is made to determine if the user wants to pursue an activity with a fixed fee or whether preauthorization is required for the transaction. Preauthorization is obtain in step 1118 as described in more detail in the flow chart of FIG. 1L. Fixed charges are added to the generic card in step 1120 as described in more detail in FIG. 1M.

Back to step 1112, if the user has not designated a generic card previously he may still use a generic card in step 1122. Details of this process are provided in the flow chart of FIG. 1L.

Back to step 1110, if the user has a preferred card, then in step 1124 a check is performed to determine if the respective preferred card has enough points or other credit to pay for the respective services. If it does, then in step 1126 the user is allowed to proceed with the requested activity and his card is debited accordingly.

If the preferred card does not have sufficient points or credits, then in step 1128 the user may be asked if he would like to add points or credit to his preferred card. If he does, the preferred card is credited in step 1130. This step is described more fully above in conjunction with the flow chart of FIG. 1C.

In step 1128, if the user elects not to credit his preferred card, then in step 1132 the user is given the choice of having the charges of using the device 12 added to his regular bill. If the user agrees, the charges are added to the regular bill as described above in step 1108. If the user does not agree, the user is not allowed access to the services provided by the device 12.

The payment process is continued in FIG. 1L which concentrates on the steps required to charge a generic card. This portion of the process is initiated in step 1200. In step 1202, the generic card is swiped by the user (unless it was swiped previously). In step 1204, a check is performed to determine if the card is a preferred or a generic card. Instead of reading a card, in step 1204, the user may be asked whether he wants to use a preferred or a generic card. If he chooses a preferred card, the processing associated with it is performed in step 1206 as described in detail above in conjunction with the flow chart of FIG. 1K.

If he user selects a generic card (but has not swiped it yet), then in step 1208 a list of acceptable (credit or debit) cards are shown to the user. In step 1210, the user swipes his generic card (if he has not done so before). If the generic card is recognized, then in step 1212 a determination is made as to whether the generic card is credit or debit card. If it is a debit card then the user is asked for a PIN number. For credit cards step 1214 may be omitted.

In step 1216, a determination is made regarding the particular activity for which payment is being collected. A fixed fee transaction is processed in step 1218 as described in more detail in FIG. 1M. Payment for pre-authorized transactions is initiated in step 1220. In step 1222, an attempt is made to obtain authorization from the bank or other institution associated with the respective generic card. If in step 1224 authorization is obtained to charge the generic card. As part of this step a small initial fee may also be charged to the generic card. In step 1226, the user is alerted to the fact that his generic card will be charged. A schedule of fees may also be provided to the user.

In step 1228, the user is allowed to engage in the desired activity and the device 12 is monitored for accrued charges. At the end of the activity, the generic card is charged with the respective total amount.

If in step 1222 authorization is not obtained, then in step 1230 the user is alerted that the generic card was refused (e.g., declined, it was invalid, expired, etc.) and the user is given the choice of trying the card again or providing another card. If another card is selected, then the process continues with step 1202. If the user selects to try again, then in step 1232 a check is performed to determine whether this is the user's third try. If it is not, then processing continues with step 1202. If this is the third try, then in step 1234 the user is alerted that the current card cannot be authorized. The user then has the option of providing another card, or terminating the process.

The process for charging a fixed fee is shown in FIG. 1M. The process is initiated in step 1300. In step 1302, an attempt is made (similar to step 1222 in FIG. 1L) to obtain authorization, but this time for a fixed fee. If authorization is received, then in step 1304 the fixed fee is charged to the card in step 1304. In step 1306, an electronic receipt is shown to the user of the actual charge on his card.

If in step 1302 no authorization is received, then in step 1308 the user is alerted that the card was rejected. He can then elect to provide another card, in which the process of FIG. 1L is initiated in step 1310. Alternatively the user may elect to try his current card a second time. If a card fails twice, the user can provide a new card in step 1312 or can elect to try the current card again. If the current card fails three times, the user is notified that the card has failed and can elect to provide another card or terminate the process.

An advantage of the present invention is that any user can manage his account and take advantage of some of the services provided by the system 10 without actually being at the restaurant or similar facility because a web site is provided which is associated with the system and which is available through an Internet connection. For example, as shown in FIG. 14N, a user in step 1400 the user can access the home page of the system 10 through the Internet. The home page may provide hot links to other sites of interest, including sites of partners providing services associated with system 10. At the home page web site, a user or a potential is provided with a menu defining several options. Selecting one of these options results in the activation of a respective step.

For example, a potential user can sign up for services. When he selects this option, step 1402 is activated. The step is used to display a sign-up form that allows the system to collect the required information from the user and store the information on the database(see FIG. 1B).

If the user elects to use the e-mail feature, then step 1404 is activated and the user is prompted to log into the e-mail server. If the user is a new user, then in step 1406 additional information relevant to the e-mail service is collected. In step 1406, new users are assigned an e-mail account. If the user made a mistake and does not want an e-mail account, the process is terminated in step 1409. Otherwise a standard e-mail service is provided in step 1410.

In step 1412, the user can select to access the reward system. In step 1414, the user can recharge his reward system card. Details of these last two steps are provided in FIG. 10.

In step 1416, the user can find a location that is participating in the reward system or a restaurant (or other similar establishment) that includes devices 12. When this option is selected, in step 1418 the user is requested for his current location, for example, by city, state, or zip code. In step 1420, a database (which may but need not be the same as database 16) is checked for the nearest location. In step 1422, the nearest location found in the database is displayed to the user.

In step 1424, the user can get more information about system 10 as described in FIG. 10. In step 1426, the user can get information about the company that owns or operates the system 10.

Back to step 1402, if potential user decides to sign up and get a preferred card, then he is requested to provide various information such as name, address, generic credit card, and the initial amount of money that is to be put on the preferred card. Information for a reward card may also be collected at the same time. In step 1428, the collected information and the terms of service including the associated costs are displayed to the user for review. If the user confirms that he wants to go ahead, in step 1430 the generic credit card is charged as discussed above for FIG. 1N. In step 1432, a master database is updated with the name and information received from the user. In step 1434, a message is sent to the user confirming that he has been registered.

FIG. 10 shows the process for accessing the reward program. If the user accesses the program through step 1432 in FIG. 14N, then the program is initiated at step 1500. In step 1502, information is displayed to the user indicating the various features of the program, details of goods, services and/or promotional literature and discounts available from various programs, etc. The user is also given the opportunity to sign up or to confirm that he is a member. If the user wants to sign up, he is directed to a sign screen in step 1504. The sign up process is disclosed in FIG. 1N.

If the user indicates that he is a member (and, preferably he is confirmed as a member), then in step 1506 the user is provided with listings of which goods, services, etc, were available from the reward program and how many points were required for each. If the user selects any of these services, then in step 1508 the pay process is instituted as discussed above and described in FIGS. 1M and 1N.

After payment is confirmed, in step 1510 a transaction database is updated and user is debited for the points used.

If step 1414 of FIG. 1N is selected, then a recharging process is initiated with step 1512.

In step 1514, the user logs his reward card in. In step 1516, the balance of points associated with the respective card is retrieved. In step 1518, the balance is displayed for the user and the user can select how many additional points he wants to buy. In step 1520, the pay process is activated to charge the user for the additional points. In step 1522, the new balance is displayed for the user.

In step 1502, the user may also elect to recharge his reward card. In this case recharging begins at step 1514.

If in step 1424 FIG. N, the user elects to see more information about the services and other information about the specific system 10, then an informational process is initiated in FIG. 1P in step 1600 by displaying specific information about the system 10, including locations, menus, etc. The user may also be provided with a survey in step 1602 regarding the services provided, the quality of food, etc. In step 1604, the user may review the responses from other users and send suggestions for improved service.

FIG. 1Q illustrates the process used for administering he operation of each device 12 at a particular location. The process is initiated in step 1700. In step 1702, a local supervisor signs into the system. In step 1704, his identity is checked. If it is not accepted, an error message is generated in step 1706. If the login is accepted, then in step 1708 a local control menu is displayed at a local control PC 42. This local menu can be used to control and edit the various information displayed on screens 30 while the respective devices 12 are in an idle mode. For example, in step 1710 a current daily special selection is designated for all the devices 12 at a particular location. In step 1712, the database 16 is updated accordingly.

In step 1714, the status of each device 12 is checked. If any of these devices is frozen or otherwise malfunctioning, it can be reset in step 1716. In step 1718, a status report is printed for future use.

FIG. 1R shows a process for administering the system 10 at a higher level. This process is used by a higher level manager to set prices and other functions. The process is initiated in step 1800. In step 1802, the manager logs into by entering his ID. In step 1804, the manager's ID is checked. If it is not correct, then an error message is generated in step 1806. If the ID is accepted, then in step 1808 a global administration menu is displayed with several selections. These selections include: managing the content and ads shown on screens 30 in step 1810 (FIG. 1S), managing the reward program, step 1812 (FIG. 1T), managing the accounts, step 1814 (FIG. 1U), managing pricing, step 1816 (FIG. 1V), synchronizing kiosks, step 1818 and viewing reports, step 1820, (FIG. 1W).

Managing kiosks?

FIG. 1S illustrates managing the content and ads to be shown on screen 30. The process is initiated at step 1900. A menu is displayed to an administrator at step 1902. One choice, adding, editing, or removing a file or URL, prompts for file name at step 1904. If the file exists, step 1906, then the administrator is prompted to edit existing data, step 1908. If the file does not exist, then a blank form is presented, step 1910, and the data base is updated step 1912.

Another menu choice, adding, editing, or removing a channel, prompts for a file name at step 1914. If the file exists, step 1916, the administrator is prompted to edit existing data for channel, step 1922. If the file does not exist, the administrator is presented with a blank form and channel attributes are set at step 1918. Then, at step 1920, the channel is added, updated or removed from a data base.

Another menu choice, editing a distribution list by kiosk, prompts the administrator at step 1924. The administrator has the option of selecting individual kiosks, groups of kiosks, or all kiosks. Then, at step 1926, a form is displayed with data for the selected kiosks. The administrator views and edits master media and URL distribution table for selected kiosks at step 1928. Then the administrator may edit existing data for a file, step 1908, or may edit existing data for a channel, step 1922.

Yet another menu choice, editing a distribution list by file name, prompts for a file name at step 1930. Then, at step 1932, a form is displayed with data for a selected file name. The administrator may view and edit a master kiosk distribution list for the selected file. Then the administrator may edit existing data for a file, step 1908, or may edit existing data for a channel, step 1922.

FIG. 1T illustrates managing the reward program, which is initiated at step 2000. One choice presented to the administrator is to add, edit, or delete a promotion. At step 2002, the administrator views a list of promotions and is prompted to choose a promotion to edit. If it is a new promotion, then the administrator sets attributes, step 2004. Then, at step 2006, a file, which may contain a graphic or coupon, is uploaded. If the promotion is not new, then promotion information is pulled from a database, step 2008. Then the administrator edits the promotion form, step 2010, and a file, which may contain a graphic or coupon is uploaded at step 2006.

Another choice, after the initiation step 2000, is to distribute coupons and other promotions. The administrator, at step 2004, selects a kiosk, a group of kiosks, or all kiosks, or selects an individual promotion. A data base form is displayed at step 2012 with kiosk data or promotion data. Then the administrator may view or edit a master promotion table at step 2014. If the administrator chooses to edit a promotion, then promotion information is pulled from a database, step 2008. Then the administrator edits the promotion form, step 2010, and a file, which may contain a graphic or coupon is uploaded at step 2006.

FIG. 1U illustrates managing the accounts and is initiated at step 2100. The administrator, at step 2112, searches for a user account. The account is retrieved at step 2116 if found. If not found, the administrator has the option of trying again, step 2114, or returning to step 1808, the global administration menu. Upon retrieving the account, the account is displayed, the administrator may edit attributes, and attributes may be activated ro deactivated, step 2118. If a refund is requested, then an amount is entered, step 2120. Any changes are written to the data base, step 2122. Then the administrator has the option to recurse at step 2116.

FIG. 1V illustrates managing pricing and is initiated at step 2200. Kiosks, individually, by group, or in the entirety, are selected at step 2202. Then a pricing table for the kiosks is displayed, step 2204. The administrator has the option of editing the pricing table, step 2206. Any changes are saved in the data base at step 2208.

FIG. 1W illustrates viewing reports and is initiated at step 2300. The administrator selects which type of report to view and which kiosks to review at step 2302. Based on the selected criteria, a report is built, step 2304. Reports to be displayed include kiosk usage (step 2306), advertising impressions (step 2308) and ad detail (step 2310), financial statistics (step 2312) and content usage (step 2314).

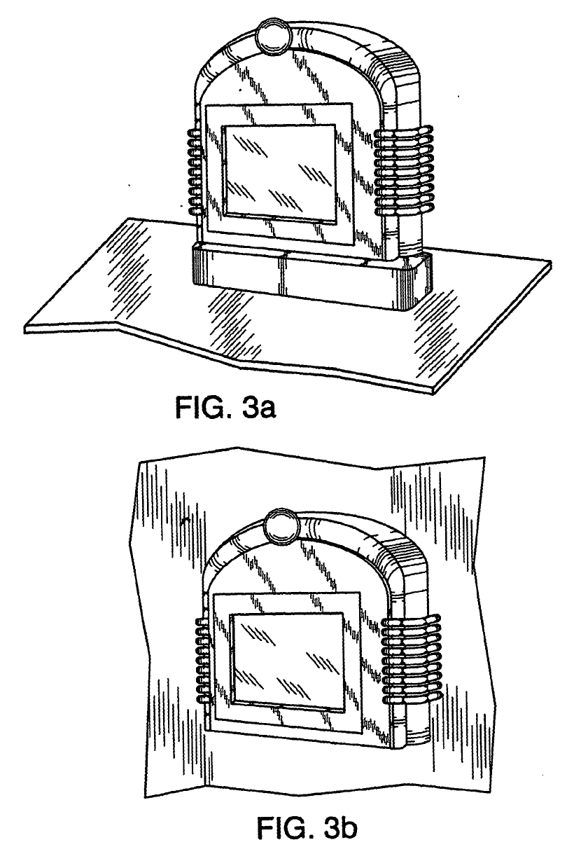

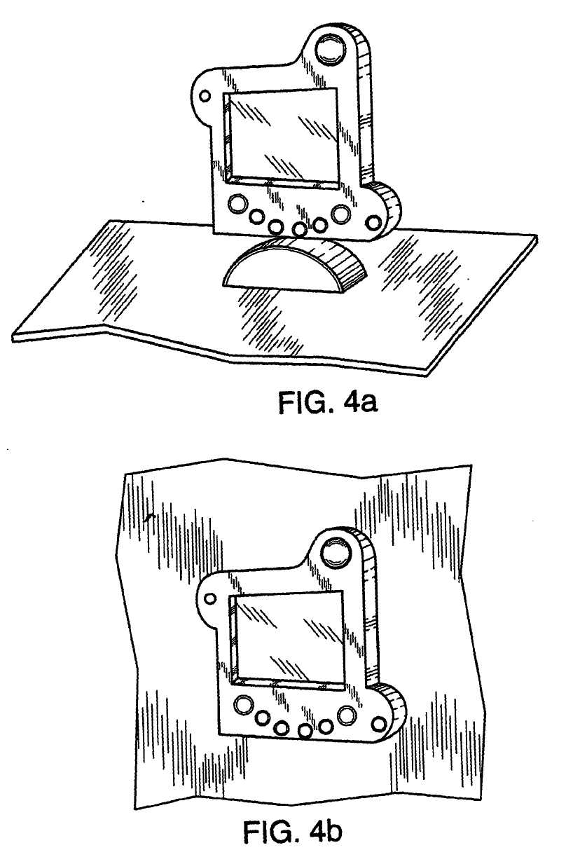

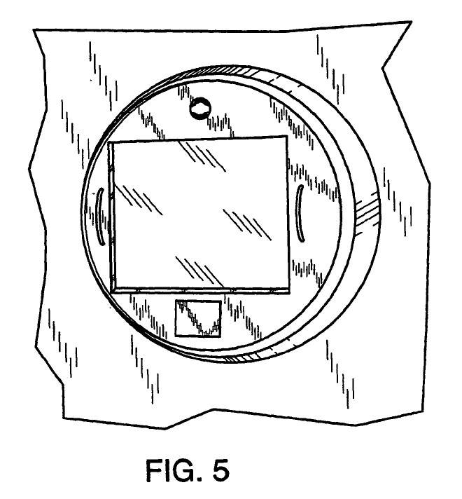

FIG. 3a is an exterior of a table top network appliance as presented to a patron. It has a touch sensitive screen, several selection buttons, and a speaker. FIG. 3b is another embodiment of the network appliance. It is a wall mounted system, also including a touch sensitive screen, several selection buttons, and a speaker. In addition, it has a slot for a card reader. FIG. 4a is a table top network appliance configured to resemble a juke box. It includes a touch sensitive screen and a speaker. The embodiment of FIG. 4b is a wall mounted system which includes a touch sensitive screen and a speaker. In addition it has a slot for a card reader.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A system for providing information and entertainment data to customers comprising:
a plurality of interactive network devices;
a server linked to the interactive network devices;
a data base accessible by the server;
and a communication network for transferring data between the interactive network devices and the server wherein said data includes only limited content.

2. The system of claim 1 wherein said interactive network devices each include:
a central processing unit;
a screen for displaying information and video images to a user;
a speaker for playing audio signals;
a card reader;
input means for user data entry;
network communication means;
means for obtaining data from a user through the card reader and input means;
means for processing the data;
and means for sharing the data with the server through the network communication means.

3. The system of claim 2 wherein the input means for user data entry further includes video game input means.

4. The system of claim 1 wherein said server is adapted to provide email to a customer.

5. The system of claim 1 wherein each device is adapted to play sound files at selectable volumes, wherein said server is adapted to adjust the volumes of two adjacent devices to limit interference.

6. A process for delivering information services from servers to interactive network devices comprising:
submitting a request for information to an interactive network device;
processing the request;
resubmitting the processed request to a server;
accessing data base information by a server in accordance with the processed request;
downloading the data base information to the interactive network device;
and outputting the data base information.

7. The process of claim 6 wherein the information services include:
steps for editing menu screens and items for display at the interactive network device;
steps for selecting menu screen items at the interactive network device;
steps for remote display of the selected screen items;
and steps for invoicing at the interactive network device for the selected screen items.

8. A method of distributing internet interactive network devices to a plurality of retail vendors comprising the steps of:
providing a plurality of interactive network devices to each vendor at substantially reduced or no cost; and
feeding content to said interactive network devices from a content provider to offset cost of said interactive network devices.

9. The method of claim 8 wherein customers subscribe to service associated with one of said retail vendors further comprising:
sending a message to said customers related to one of said retail vendors.

10. The method of claim 8 wherein said content defines services that are selected by said customers from a group consisting at least of musical selections, email, internet, video selections, menu selections associated with retail vendor, and games.

11. The method of claim 10 further comprising associating a charge card with each customer to pay for said services.

12. The method of claim 11 further comprising providing free content to said customer when said customer has elected to receive and pay for said services.
